(19) United States
(12) Patent Application Publication
(10) Pub. No.: US 2011/0111902 A1
(43) Pub. Date: May 12, 2011

(54) Oil-resistant drive belt, particulary toothed belt

(75) Inventors: Michael Well, Vechelde (DE); Reinhard Teves, Seelze (DE); Hermann Schulte, Garbsen (DE); Axel Unruh, Hannover (DE); Jens-Peter Schemeit, Peine (DE)

(73) Assignee: ContiTech Antriebssysteme GmbH

(21) Appl. No.: 12/929,299

(22) Filed: Jan. 13, 2011

Related U.S. Application Data
(63) Continuation of application No. PCT/EP09/56051, filed on May 19, 2009.

(30) Foreign Application Priority Data
Jul. 15, 2008 (DE) 10 2008 033 267.4

(51) Int. Cl. F16G 1/10; F16G 1/28

(52) U.S. Cl. 474/205; 474/204

(57) ABSTRACT

The invention relates to a drive belt (1), particularly a toothed belt, having an elastic base body, comprising a cover layer (2) as the belt back, and a subframe (4) having a power transmission zone (7), wherein the base body is made from oil-resistant vulcanized rubber on the basis of a copolymer comprising butadiene and acrylonitrile, particularly HNBR, wherein according to the invention the proportion of acrylonitrile (CAN proportion) is <33% by weight with regard to the total weight of the copolymer. The particularly advantageous CAN proportion is 20 to 35% by weight. The power transmission zone (7) is typically also equipped with a textile cover (8), which is further provided with an oil-resistant protective layer (9), which is preferably made from PTFE.

### CROSS REFERENCE TO RELATED APPLICATIONS

This application is a continuation application of international patent application PCT/EP 2009/056051, filed May 19, 2009, designating the United States and claiming priority from German application 10 2008 033 267.4, filed Jul. 15, 2008, and the entire content of both applications is incorporated herein by reference.

### FIELD OF THE INVENTION

The invention relates to a drive belt with an elastic base body, comprising a cover layer as a belt backing and a substructure with a power transmission zone, said base body consisting of an oil-resistant vulcanizate based on a copolymer of butadiene and acrylonitrile. Such a copolymer is also known as nitrile butadiene rubber (NBR).

### BACKGROUND OF THE INVENTION

Drive belts, which are also referred to as power transmission belts, and which form a continuous loop in the working state, can also be configured as flat belts, V belts, V-ribbed belts and toothed belts. Of particular significance here is the toothed belt, to which reference is made especially in the following patent literature: EP 0 599 145 B1; EP 0 737 228 B1; EP 0 866 834 B1; EP 1 088 177 B1 (U.S. Pat. No. 6,419,775 B1); EP 1 129 308 B1; WO 2005/080821 A1; WO 2006/066669 A1 (U.S. 2008/0032837 A1); and, U.S. Pat. No. 5,417,618.

Published specification WO 2005/080821 A1, which should be considered here to be the closest prior art, presents a vulcanizate based on NBR, especially HNBR, in which the proportion of acrylonitrile (ACN content) in relation to the total weight of the copolymer is 33 to 49% by weight. For optimal oil resistance, it has been assumed to date that an ACN content of >33% by weight is required. However, disadvantages arise with regard to cold flexibility in the case of a high ACN content. For example, toothed belts made from HNBR with an ACN content of >33% by weight have a lower use temperature of −25° C. At lower temperatures, the drive belt cracks and fails.

### SUMMARY OF THE INVENTION

In the course of further development, it is therefore an object of the invention to provide a drive belt, especially a toothed belt, of this type, which features improved low-temperature flexibility under oil operating conditions with improved swelling performance, combined with an increased lifetime of the drive belt.

This object is achieved by virtue of the proportion of acrylonitrile (ACN content) in relation to the total weight of the copolymer, which is especially a (partly) hydrogenated nitrile rubber (HNBR), being <33% by weight.

The ACN content is especially ≦32% by weight. With regard to further advantageous amounts, reference is made to claims 4 to 8. A series of experiments has shown that the best results are achieved with regard to the objective at an ACN content of 20 to 25% by weight.

The vulcanized rubber mixture also comprises mixture ingredients in addition to the rubber component, especially HNBR. The mixture ingredients in turn comprise at least one crosslinker or a crosslinker system (crosslinking agent and accelerator). Further common mixture ingredients are a filler and/or a processing aid and/or a plasticizer and/or an ageing stabilizer, and optionally further additives (e.g. fibers, color pigments). Advantageously, fibers of aramid, cotton, charcoal or cellulose are added in homogeneous distribution to the rubber mixture, preference being given to using aramid fibers, and among these especially para-aramid fibers.

Otherwise, reference is made to the general state of rubber blending technology.

In the course of a test procedure, a toothed belt blend I based on HNBR according to WO 2005/080821 A1 has been compared to the new toothed belt blend II based on low-temperature HNBR. Table 1 contains the composition of the blend crosslinked peroxidically in each case in phr (per hundred of rubber), and Table 2 the results.

TABLE 1

| Blend constituents | I | II |
|---|---|---|
| HNBR (a) | 100 | — |
| Low-temperature HNBR (b) | — | 100 |
| Carbon black (c) | 15 | 15 |
| Silica (d) | 15 | 15 |
| Aramid fibers (e) | 7 | 7 |
| Zinc dimethacrylate | 25 | 25 |
| Stearic acid | 1 | 1 |
| Plasticizer (f) | 5 | 5 |
| Zinc oxide | 6 | 6 |
| Ageing stabilizer (g) | 2.5 | 2.5 |
| Peroxide (h) | 7 | 7 |

(a) ACN content of 34% by weight, residual double bond content of 4%
(b) ACN content of 21% by weight, residual double bond content of 5.5% (Therban ® LT 2157 from Lanxess)
(c) carbon black types: SAF, ISAF, HAF, FEF or GPF
(d) finely divided silica
(e) 3 mm para-aramid fibers (e.g. Twaron ® fibers or Technora ® fibers)
(f) esters of trimellitic acid
(g) zinc salt of methylmercaptobenzimidazole
(h) di(tert-butylperoxyisopropyl)benzene

TABLE 2

| | Figures | | |
|---|---|---|---|
| Criteria | in | I | II |
| MDR 2000, 180° C. | | | |
| Fe-Fa | dNm | 43.86 | 24.27 |
| T10 | min | 0.32 | 0.33 |
| T90 | min | 4.58 | 6.43 |
| Heating time 20 min, 180° C. | | | |
| Hardness | Shore A | 87 | 87 |
| Strength (l*) | MPa | 17.0 | 18.2 |
| Strength (t**) | MPa | 15.7 | 13.6 |
| Elongation (l) | % | 81 | 32 |
| Elongation (t) | % | 267 | 289 |
| Stress value (20%) (l) | MPa | 16.5 | 17.9 |
| Stress value (20%) (t) | MPa | 3.1 | 2.5 |
| Swelling in 5W40 motor oil | | | |
| (7 days at 130° C.) | | | |
| Volume swelling | % | −5.21 | −0.70 |
| Weight swelling | % | −4.36 | −1.01 |
| Hardness | Shore A | 90 | 86 |
| Strength (l) | MPa | 21.3 | 19.9 |
| Strength (t) | MPa | 18.8 | 14.6 |
| Elongation (l) | % | 50 | 22 |
| Elongation (t) | % | 147 | 201 |
| Stress value (20%) (l) | MPa | 21.5 | 17.45 |
| Stress value (20%) (t) | MPa | 5.0 | 3.1 |

*longitudinal
**transverse

The results in Table 2 are based on the following test methods:

Hardness: DIN 53504

Strength, elongation, stress values: DIN 53504, DIN 53455, DIN 53571

Swelling: DIN 51521

As Table 1 illustrates, only the HNBR with an ACN content of 34% by weight was replaced with an HNBR having a significantly lower ACN content of 21% by weight, with otherwise the same blend constituents and amounts. As the results in Table 2 demonstrate, the inventive drive belt fully achieves the objective stated at the outset. What is especially surprising is the improved swelling performance under oil operating conditions. The data further demonstrate an increased lifetime.

### BRIEF DESCRIPTION OF THE DRAWINGS

The invention will now be described with reference to the drawings wherein:

FIG. 1 shows a three-dimensional diagram of a toothed belt with a top view of the force transmission zone;

FIG. 2 shows a longitudinal section through a toothed belt with a protective layer for the force transmission zone and for the belt backing.

### DESCRIPTION OF THE PREFERRED EMBODIMENTS OF THE INVENTION

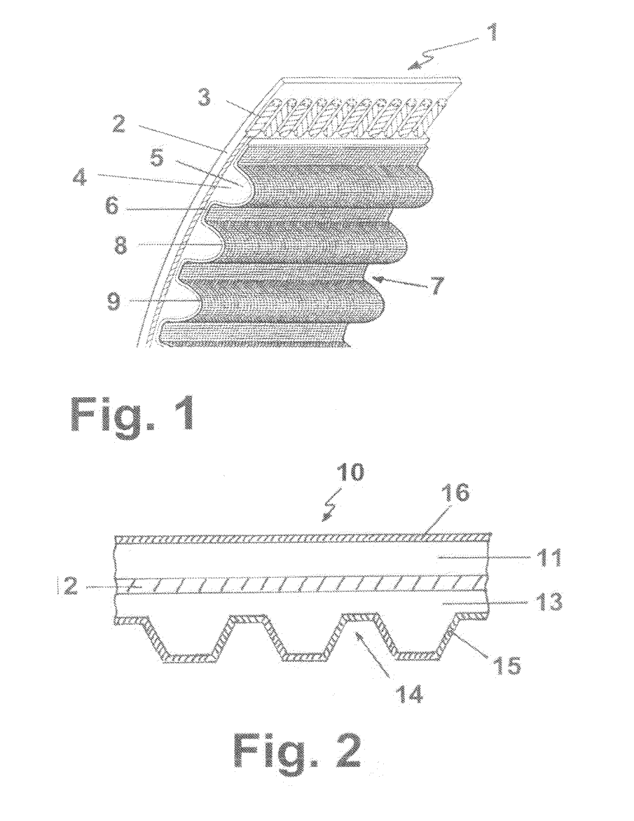

FIG. 1 shows a drive belt 1 in the form of a toothed belt with a cover layer 2 as a belt backing, with a plurality embedded and parallel tensile strands 3 as strengthening elements, and with a substructure 4. The cover layer and the substructure, as an overall unit, form the elastic base body which consists of a vulcanizate based on a (partly) hydrogenated nitrile rubber (HNBR) with an ACN content of <33% by weight. The tensile strands consist of steel, polyamide, aramid, polyester, glass fibers, carbon fibers, polyetheretherketone (PEEK) or polyethylene 2,6 naphthalate (PEN).

The substructure 4 is provided with a toothed profile comprising teeth 5 and indentations 6, and forms the power transmission zone 7, which is particularly prone to wear as a result of abrasion, heat and the influence of oils. For this reason, there have already been proposals to provide the power transmission zone with a textile overlay 8, for example in the form of a woven or knitted fabric. This woven overlay is, according to the teaching of document WO 2005/080821 A1, additionally impregnated with a fluorinated polymer, which is especially PTFE, specifically at a high filling level of this polymer, with simultaneous formation of a polymer coating (seal) as an additional oil-resistant protective layer 9. The two sublayers 8 and 9 with different functions are provided here as a combined protective layer.

The drive belt 10 according to FIG. 2, again in the form of a toothed belt, comprises a cover layer 11 as a belt backing, tensile strands 12 and a substructure 13 with a toothed power transmission zone 14. The power transmission zone, like the belt backing, is provided with an oil-resistant protective layer 15 and 16.

With regard to the protective layers 15 and 16, the following material variants are preferably implemented.

The protective layer consists exclusively of polyurethane.

The protective layer consists exclusively of a fluorinated polymer, which is especially polytetrafluoroethylene (PTFE), polyvinyl fluoride (PVF) or polyvinylidene fluoride (PVDF). PTFE is of particular significance.

The protective layer consists of a mixture of polyurethane and a fluorinated polymer, especially of PTFE, PVF or PVDF, again especially of PTFE.

The protective layers 15 and 16 may, as in the implementation according to WO 2005/080821 A1, be connected to a textile overlay, for example of a woven fabric.

However, these oil-resistant materials may also be used in the form of films or of a film composite, more particularly without use of a textile overlay. In this respect, reference is made especially to the more recent development according to DE 10 2008 012 044.8.

Such protective layers are employed especially in high-performance toothed belts.

It is understood that the foregoing description is that of the preferred embodiments of the invention and that various changes and modifications may be made thereto without departing from the spirit and scope of the invention as defined in the appended claims.

### LIST OF REFERENCE NUMERALS

### (Part of the Description)

1 Drive belt (toothed belt)
2 Cover layer as belt backing
3 Strengthening elements in the form of tensile strands
4 Substructure
5 Tooth
6 Indentation
7 Power transmission zone
8 Textile overlay (tooth overlay)
9 Protective layer
10 Drive belt. (toothed belt)
11 Cover layer as belt backing
12 Strengthening elements in the form of tensile strands
13 Substructure
14 Power transmission zone
15 Protective layer for the power transmission zone
16 Protective layer for the belt backing

What is claimed is:

1. A drive belt with an elastic base body, comprising a cover layer as a belt backing and a substructure with a power transmission zone, the base body consisting of an oil-resistant vulcanizate based on a copolymer of butadiene and acrylonitrile, characterized in that the proportion of acrylonitrile in relation to the total weight of the copolymer is <33% by weight.

2. The drive belt as claimed in claim 1, wherein the copolymer is a (partly) hydrogenated nitrile rubber (HNBR).

3. The drive belt as claimed in claim 1, wherein the proportion of acrylonitrile is ≦32% by weight.

4. The drive belt as claimed in claim 1, wherein the proportion of acrylonitrile is ≧10% by weight.

5. The drive belt as claimed in claim 1, wherein the proportion of acrylonitrile is ≧15% by weight.

6. The drive belt as claimed in claim 1, wherein the proportion of acrylonitrile is ≧20% by weight.

7. The drive belt as claimed in claim 1, wherein the proportion of acrylonitrile is 20 to 30% by weight.

8. The drive belt as claimed in claim 1, wherein the proportion acrylonitrile is 20 to 25% by weight.

9. The drive belt as claimed in claim 1, wherein fibers are blended into the vulcanizate.

10. The drive belt as claimed in claim 9, wherein the fibers consist of aramid, cotton, charcoal or cellulose.

11. The drive belt as claimed in claim 10, wherein the fibers consist of aramid.

12. The drive belt as claimed in claim 11, wherein the fibers consist of para-aramid.

13. The drive belt as claimed in claim 1, wherein at least the power transmission zone is provided with an additional oil-resistant protective layer.

14. The drive belt as claimed in claim 13, wherein the power transmission zone and the cover layer are provided with an additional oil-resistant protective layer.

15. The drive belt as claimed in claim 13, wherein the oil-resistant protective layer consists of polyurethane.

16. The drive belt as claimed in claim 13, wherein the oil-resistant protective layer consists of a fluorinated polymer.

17. The drive belt as claimed in claim 13, wherein the oil-resistant protective layer consists of a mixture of polyurethane and a fluorinated polymer.

18. The drive belt as claimed in claim 16, wherein the fluorinated polymer is polytetrafluoroethylene (PTFE), polyvinyl fluoride (PVF) or polyvinylidene fluoride (PVDF).

19. The drive belt as claimed in claim 18, wherein the fluorinated polymer is PTFE.

20. The drive belt as claimed in claim 1, wherein the drive belt is configured as a toothed belt.
